(19) United States
(12) Patent Application Publication
(10) Pub. No.: US 2014/0201982 A1
(43) Pub. Date: Jul. 24, 2014

(54) LITHIUM-ION SECONDARY BATTERY, BATTERY STACK, AND METHOD OF MANUFACTURING LITHIUM-ION SECONDARY BATTERY

(71) Applicant: Tetsuya Waseda, Toyota-shi (JP)

(72) Inventor: Tetsuya Waseda, Toyota-shi (JP)

(21) Appl. No.: 14/239,282

(22) PCT Filed: Aug. 30, 2011
(86) PCT No.: PCT/JP2011/004829

§ 371 Date: Feb. 18, 2014

(51) Int. Cl. H01M 10/058

(52) U.S. Cl. CPC H01M 10/058
USPC 29/623.1

(57) ABSTRACT

A lithium-ion secondary battery includes a positive electrode plate, a negative electrode plate, and a separator. The positive electrode plate includes a positive electrode collector plate and a positive electrode active material layer formed on the surface of the positive electrode collector plate. The negative electrode plate includes a negative electrode collector plate and a negative electrode active material layer formed on the surface of the negative electrode collector plate. The separator is disposed between the positive electrode plate and the negative electrode plate. The positive electrode plate, the negative electrode plate, and the separator are stacked and wound, and each of them includes a flat portion disposed along a plane and bearing an external load and a curved portion formed to be curved. The positive electrode active material layer includes a flat region corresponding to the flat portion and a curved region corresponding to the curved portion. The density of the positive electrode active material layer in at least a portion of the curved region is higher than the density of the positive electrode active material layer in the flat region.

### CROSS-REFERENCE TO RELATED APPLICATIONS

This application is a national phase application of International Application No. PCT/JP2011/004829, filed Aug. 30, 2011, the content of which is incorporated herein by reference.

### TECHNICAL FIELD

The present invention relates to a lithium-ion secondary battery including a positive electrode plate and a negative electrode plate wound with a separator sandwiched between them, a battery stack including a plurality of such lithium-ion secondary batteries, and a method of manufacturing the lithium-ion secondary battery.

### BACKGROUND ART

A lithium-ion secondary battery has a power-generating element capable of charge and discharge, and a battery case accommodating the power-generating element. The power-generating element has a positive electrode plate, a negative electrode plate, and a separator disposed between the positive electrode plate and the negative electrode plate. The positive electrode plate, the negative electrode plate, and the separator are stacked and wound to provide the power-generating element.

In a so-called square-type battery, a battery case is formed to conform to a rectangle, and a power-generating element is formed to have a shape conforming to the battery case. Specifically, the power-generating element is formed in a flattened shape and has a flat portion conforming to the battery case and a curved portion connected to the flat portion. In the flat portion, the positive electrode plate, the negative electrode plate, and the separator are stacked along a plane. In the curved portion, the positive electrode plate, the negative electrode plate, and the separator are curved.

### PRIOR ART DOCUMENT

### Patent Document

[Patent Document 1] Japanese Patent Laid-Open No. 2006-040899

### DISCLOSURE OF THE INVENTION

### Problems to be Solved by the Invention

A restraint force may be applied to the square-type battery. The restraint force refers to a force which presses and holds the battery tightly. The restraint force is applied to the battery case and acts on the flat portion of the power-generating element. It is difficult to exert the restraint force on the curved portion of the power-generating element. If the flat portion and the curved portion of the power-generating element are under different loads, lithium may tend to be precipitated in the curved portion.

### Means for Solving the Problems

According to a first aspect, the present invention provides a lithium-ion secondary battery including a positive electrode plate, a negative electrode plate, and a separator. The positive electrode plate includes a positive electrode collector plate and a positive electrode active material layer formed on the surface of the positive electrode collector plate. The negative electrode plate includes a negative electrode collector plate and a negative electrode active material layer formed on the surface of the negative electrode collector plate. The separator is disposed between the positive electrode plate and the negative electrode plate. The positive electrode plate, the negative electrode plate, and the separator are stacked and wound, and the wound stack includes a flat portion disposed along a plane and bearing an external load and a curved portion formed to be curved. The positive electrode active material layer includes a flat region corresponding to the flat portion and a curved region corresponding to the curved portion. The density of the positive electrode active material layer in at least a portion of the curved region is higher than the density of the positive electrode active material layer in the flat region.

The thickness of at least the portion of the curved region can be smaller than the thickness of the flat region. This allows the density in at least the portion of the curved region to be higher than the density in the flat region. The positive electrode active material layer can be formed of a plurality of materials contained at a substantially equal ratio in both the flat region and the curved region. In this case, merely providing the different thicknesses for the curved region and the flat region can achieve the different densities for the curved region and the flat region.

The amount of a conductive agent included in at least the portion of the curved region can be larger than the amount of a conductive agent included in the flat region. This also allows the density in at least the portion of the curved region to be higher than the density in the flat region.

The density D_{C} in at least the portion of the curved region and a density D_{F} in the flat region preferably satisfy a condition represented by the following expression (I):

1.0<D_{C}/D_{F}<1.2 (I)

The ratio between the densities D_{C} and D_{F} larger than 1.0 can provide the density D_{C} higher than the density D_{F}. The ratio between the densities D_{C} and D_{F} smaller than 1.2 can reduce the adverse effect when the lithium-ion secondary battery is charged or discharged at a high rate. Specifically, the ratio smaller than 1.2 can prevent the shortening of the discharge time or the progression of deterioration involved in the discharge at the high rate.

The density of the negative electrode active material layer can be substantially uniform over the entire negative electrode active material layer. The lithium-ion secondary battery according to the present invention can output an energy used as a kinetic energy for running a vehicle.

The lithium-ion secondary battery according to the present invention can be used in a battery stack. The battery stack includes a plurality of lithium-ion secondary batteries aligned in a predetermined direction, and a restraint mechanism applying a restraint force in the predetermined direction to the plurality of lithium-ion secondary batteries. At least one of the plurality of lithium-ion secondary batteries can be the lithium-ion secondary battery according to the present invention.

According to a second aspect, the present invention provides a method of manufacturing a lithium-ion secondary battery including the steps of producing a positive electrode plate and producing a negative electrode plate. The positive electrode plate, the negative electrode plate, and a separator disposed between the positive electrode plate and the negative electrode plate are stacked and wound, and the wound stack has a flat portion disposed along a plane and bearing an external load and a curved portion formed to be curved. The positive electrode active material layer includes a flat region corresponding to the flat portion and a curved region corresponding to the curved portion. In the formation of the positive electrode active material layer on the surface of a positive electrode collector plate, the density in at least a portion of the curved region is set to be higher than the density in the flat region.

The thickness of at least the portion of the curved region can be set to be smaller than the thickness of the flat region. This allows the density in at least the portion of the curved region to be higher than the density in the flat region. The thickness of at least the portion of the curved region can be set to be smaller than the thickness of the flat region by using a roller. The roller is movable between a position where the roller presses the positive electrode active material layer and a position where the roller is separate from the positive electrode active material layer. Before the roller presses the positive electrode active material layer, the positive electrode active material layer can be formed by applying a plurality of materials forming the positive electrode active material layer at a substantially equal content ratio to the positive electrode collector plate.

### Advantage of the Invention

According to the present invention, local precipitation of lithium can be suppressed in the curved portion in which the load is applied less effectively.

### BRIEF DESCRIPTION OF THE DRAWINGS

FIG. 1 is a top view of a battery stack.

FIG. 2 is an external view of a battery.

FIG. 3 is a schematic diagram showing the internal structure of the battery.

FIG. 4 is a developed view of part of a power-generating element.

FIG. 5 is a schematic diagram showing a structure for applying a restraint force to the battery.

FIG. 6 is a schematic diagram showing the configuration of the power-generating element disposed inside the battery.

FIG. 7 is an enlarged view of a section of a positive electrode plate.

FIG. 8 is a developed view of the positive electrode plate.

FIG. 9 is a diagram for explaining part of a process of manufacturing the positive electrode plate.

FIG. 10 is a graph showing capacity retention rates in an example in which a positive electrode active material layer has varied densities and a comparative example in which a positive electrode active material layer has a uniform density.

FIG. 11 is a graph showing the relationship between an amount of voltage drop and a discharge time.

### MODE FOR CARRYING OUT THE INVENTION

An embodiment of the present invention will hereinafter be described.

### Embodiment 1

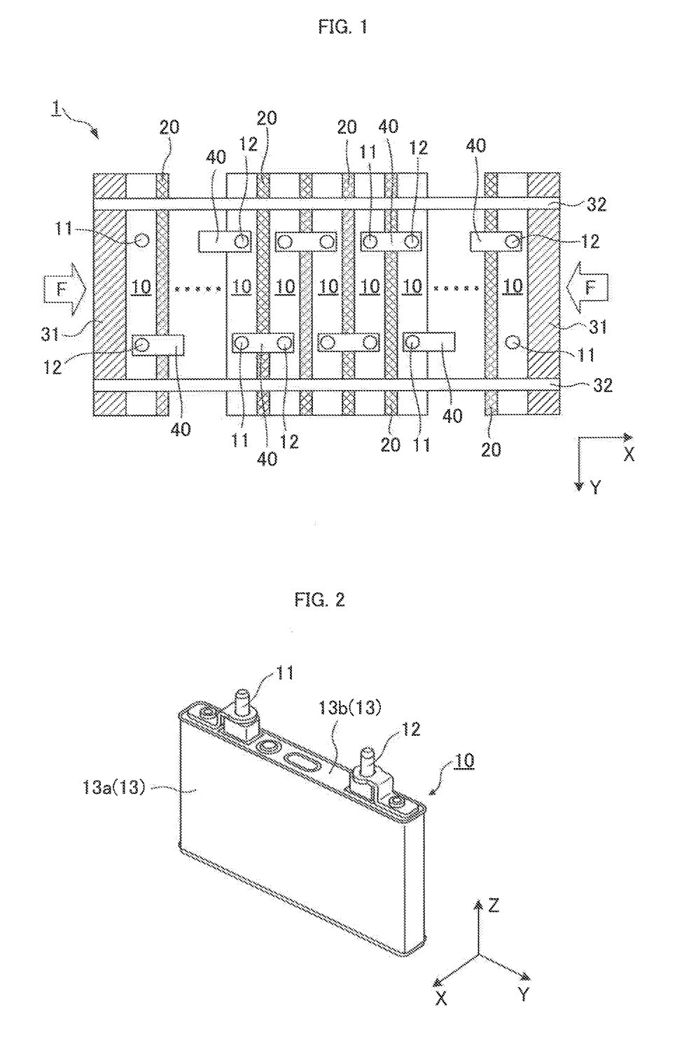

A battery stack which is Embodiment 1 of the present invention is described with reference to FIG. 1. FIG. 1 is a top view of the battery stack. In FIG. 1, an X axis and a Y axis are axes orthogonal to each other. A Z axis is an axis orthogonal to the X axis and the Y axis and corresponds to a vertical direction in the present embodiment.

The battery stack 1 has a plurality of batteries 10 aligned in the X direction. The battery 10 is a lithium-ion secondary battery and a so-called square-type battery. A partitioning plate 20 is disposed between two of the batteries 10 adjacent to each other in the X direction. The partitioning plate 20 can be made of resin, for example. A pair of end plates (part of a restraint mechanism) 31 are disposed at both ends of the battery stack 1 in the X direction. The endplate 31 can be made of resin, for example. A restraint band (part of the restraint mechanism) 32 extending in the X direction is fixed at both ends to the pair of end plates 31.

As shown in FIG. 1, two such restraint bands 32 are placed on an upper face of the battery stack 1. Although not shown, two such restraint bands 32 are also placed on a lower face of the battery stack 1. The fixing of the restraint bands 32 to the pair of end plates 31 can apply a restraint force F to the plurality of batteries 10 sandwiched between the pair of end plates 31. The restraint force F is a force which presses and holds the batteries 10 tightly in the X direction.

The plurality of batteries 10 are connected electrically in series through bus bars 40. Specifically, in two of the batteries 10 adjacent to each other in the X direction, a positive electrode terminal 11 of one battery 10 is connected electrically to a negative electrode terminal 12 of the other battery 10 through the bus bar 40. The number of the batteries 10 constituting the battery stack 1 can be set as appropriate based on the output and the like required of the battery stack 1. Although the plurality of batteries 10 are connected electrically in series in the present embodiment, the present invention is not limited thereto. The battery stack 1 may include a plurality of batteries 10 connected electrically in parallel.

The battery stack 1 can be housed in a pack case (not shown). The battery stack 1 and the pack case constitute a battery pack. The battery pack can be mounted on a vehicle, for example. An electric energy output from the battery pack (battery stack 1) can be converted into a kinetic energy by a motor generator and the kinetic energy can be used to run the vehicle. A kinetic energy generated in braking of the vehicle can be converted into an electric energy by the motor generator and the electric energy can be stored in the battery pack (battery stack 1).

Next, the configuration of the battery 10 is described specifically.

FIG. 2 is an external view of the battery 10. A battery case 13 forms the exterior of the battery 10, and can be made of metal, for example. The battery case 13 is formed in a shape conforming to a rectangle and has a case body 13a and a lid 13b. The case body 13a has an opening for inserting a power-generating element 14, later described, and the lid 13b closes the opening of the case body 13a. The lid 13b can be fixed to the case body 13a to hermetically seal the battery case 13. The positive electrode terminal 11 and the negative electrode terminal 12 are fixed to the lid 13b.

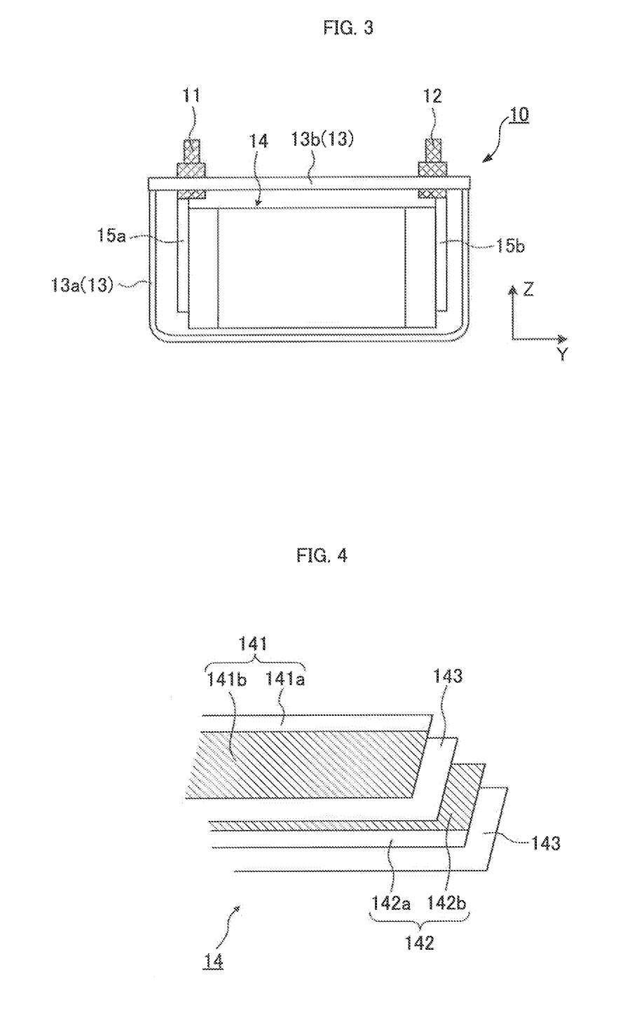

FIG. 3 is a schematic diagram showing the internal structure of the battery 10. The battery case 13 accommodates the power-generating element 14. One end portion of the power-generating element 14 in the Y direction is connected to a positive electrode tab 15a, and the positive electrode tab 15a is also connected to the positive electrode terminal 11. The positive electrode tab 15a can be connected to the power-generating element 14 and the positive electrode terminal 11 by welding or the like. The positive electrode tab 15a can be made of aluminum, for example. Although the positive electrode tab 15a and the positive electrode terminal 11 are independent members in the present embodiment, the positive electrode tab 15a and the positive electrode terminal 11 may be formed integrally.

The other end portion of the power-generating element 14 in the Y direction is connected to a negative electrode tab 15b, and the negative electrode tab 15b is also connected to the negative electrode terminal 12. The negative electrode tab 15b can be connected to the power-generating element 14 and the negative electrode terminal 12 by welding or the like. The negative electrode tab 15b can be made of copper, for example. Although the negative electrode tab 15b and the negative electrode terminal 12 are independent members in the present embodiment, the negative electrode tab 15b and the negative electrode terminal 12 may be formed integrally.

FIG. 4 is a developed view of part of the power-generating element 14. As shown in FIG. 4, the power-generating element 14 has a positive electrode plate 141, a negative electrode plate 142, and a separator 143. The positive electrode plate 141 has a collector plate 141a and a positive electrode active material layer 141b formed on the surface of the collector plate 141a. The positive electrode active material layer 141b is formed on both faces of the collector plate 141a. The collector plate 141a can be made of aluminum, for example.

The positive electrode active material layer 141b includes a positive electrode active material, a conductive agent, a binder and the like. The positive electrode active material can be provided by using LiCoO₂, LiMn₂O₄, LiNiO₂, LiFePO₄, Li₂FePO₄F, LiCo_{1/3}Ni_{1/3}Mn_{1/3}O₂, and Li (LiₐNiₓMn_{y}Co_{z}) O₂, for example. The positive electrode active material layer 141b is formed on a part of region of the collector plate 141a such that the collector plate 141a is exposed at one end of the positive electrode plate 141.

The negative electrode plate 142 has a collector plate 142a and a negative electrode active material layer 142b formed on the surface of the collector plate 142a. The negative electrode active material layer 142b is formed on both faces of the collector plate 142a. The collector plate 142a can be made of copper, for example. The negative electrode active material layer 142b includes a negative electrode active material, a conductive agent, a binder and the like. The negative electrode active material can be provided by using carbon, for example. The negative electrode active material layer 142b is formed on a part of region of the collector plate 142a such that the collector plate 142a is exposed at one end of the negative electrode plate 142. The separator 143, the positive electrode active material layer 141b, and the negative electrode active material layer 142b are impregnated with an electrolytic solution.

The positive electrode plate 141, the negative electrode plate 142, and the separator 143 are stacked in the order shown in FIG. 4 and the stack is wound to provide the power-generating element 14. In FIG. 3, at one end of the power-generating element 14 in the Y direction, only the collector plate 141a of the positive electrode plate 141 is wound. The positive electrode tab 15a is connected to that end of the collector plate 141a. At the other end of the power-generating element 14 in the Y direction, only the collector plate 142a of the negative electrode plate 142 is wound. The negative electrode tab 15b is connected to that end of the collector plate 142a.

Areas of the positive electrode active material layer 141b and the negative electrode active material layer 142b that are opposed to each other with the separator 143 interposed therebetween correspond to an area (referred to as a reaction area) where a chemical reaction occurs depending on charge or discharge of the battery 10. In the reaction area, lithium ions are moved between the positive electrode active material layer 141b and the negative electrode active material layer 142b depending on charge or discharge of the battery 10.

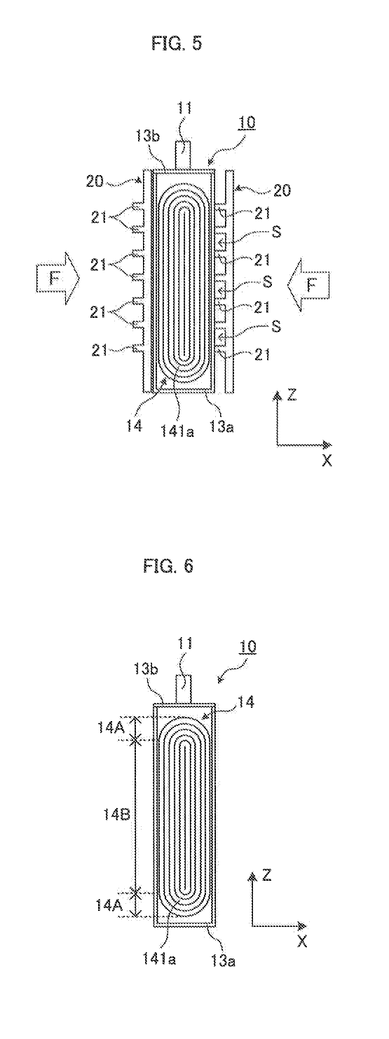

FIG. 5 is a diagram showing the restraint on the battery 10. Two partitioning plates 20 are disposed at the positions between which the battery 10 is sandwiched in the X direction. The partitioning plate 20 has a plurality of protruding portions 21 on one face and a flat surface on the other face. The battery 10 is in contact with the protruding portions 21 formed on one of the partitioning plates 20 (partitioning plate 20 on the right in FIG. 5) and is in contact with the flat surface on the other partitioning plate 20 (partitioning plate 20 on the left in FIG. 5).

The plurality of protruding portions 21 are aligned in the Z direction, and each of the protruding portions 21 extends in the Y direction. The tip of the protruding portion 21 contacts the battery 10 to form a space S between the partitioning plate 20 and the battery 10. The space S serves as a path through which a heat exchange medium used in adjusting the temperature of the battery 10 passes. The heat exchange medium can be provided by using air or gas having components different from those of air.

The shape of the protruding portion 21 in a Y-Z plane can be set as appropriate. It is only required that the tip of the protruding portion 21 should contact the battery 10 to form the space S between the partitioning plate 20 and the battery 10.

When the battery 10 produces heat due to charge or discharge, a heat exchange medium for cooling can be passed through the space S. The heat exchange medium for cooling can exchange heat with the battery 10 to suppress arise in temperature of the battery 10. When the battery 10 is excessively cooled, a heat exchange medium for heating can be passed through the space S. The heat exchange medium for heating can exchange heat with the battery 10 to suppress a reduction in temperature of the battery 10.

In the present embodiment, after the stack of the positive electrode plate 141, the negative electrode plate 142, and the separator 143 is wound, the resulting power-generating element 14 is formed into a flattened shape. Thus, as shown in FIG. 6, the power-generating element 14 has curved portions 14A and a flat portion 14B. The curved portion 14A is positioned at each end (upper end and lower end) of the power-generating element 14 in the Z direction, and the flat portion 14B is positioned between the two curved portions 14A.

In the curved portion 14A, the positive electrode plate 141, negative electrode plate 142, and separator 143 are stacked and curved. In the curved portion 14A positioned at the upper end of the power-generating element 14, the positive electrode plate 141, the negative electrode plate 142, and the separator 143 are curved to protrude toward the lid 13b. In the curved portion 14A positioned at the lower end of the power-generating element 14, the positive electrode plate 141, the negative electrode plate 142, and the separator 143 are curved to protrude toward a bottom face of the case body 13a. In the flat portion 14B, the positive electrode plate 141, the negative electrode plate 142, and the separator 143 are stacked along a plane (Y-Z plane).

As shown in FIG. 5, the flat portion 14B of the power-generating element 14 is opposite to the protruding portions 21 of the partitioning plate 20 in the X direction, so that the restraint force F acts on the flat portion 14B. In contrast, the curved portion 14A of the power-generating element 14 is not opposite to the protruding portions 21 of the partitioning plate 20, so that the restraint force F acts on the curved portion 14A less effectively. It is found that lithium tends to be precipitated in the curved portion 14A than in the flat portion 14B.

Since the long positive electrode plate 141 is wound in the power-generating element 14, the positive electrode plate 141 has a region (referred to as a curved region) corresponding to the curved portion 14A and a region (referred to as a flat region) corresponding to the flat portion 14B. The restraint force F acts effectively on the flat region of the positive electrode plate 141 and acts less effectively on the curved region of the positive electrode plate 141.

This easily produces variations in current density during charge and discharge between the curved region and the flat region of the positive electrode plate 141. The restraint force F exerted on the flat region of the positive electrode plate 141 can pass an electric current substantially uniformly over the entire flat region. In contrast, the restraint force F acts less effectively on the curved region of the positive electrode plate 141, so that the curved region tends to include both a region where the current smoothly flows and a region where the current does not smoothly flows.

When the variations in current density occur between the curved region and the flat region of the positive electrode plate 141, such variations in current density also occur in the negative electrode plate 142 opposite to the positive electrode plate 141. The negative electrode plate 142 also includes a region (referred to as a curved region) corresponding to the curved portion 14A and a region (referred to as a flat region) corresponding to the flat portion 14B. The variations in current density occurring between the curved region and the flat region of the negative electrode plate 142 easily cause local precipitation of lithium in the curved region of the negative electrode plate 142.

Depending on the deterioration state of the battery 10, lithium may also be precipitated in the flat region of the negative electrode plate 142. The state of lithium precipitation in the flat region of the negative electrode plate 142 is different from the state of lithium precipitation in the curved region of the negative electrode plate 142. Lithium may be precipitated over the entire flat region of the negative electrode plate 142. In contrast, lithium is precipitated not over the entire curved region but in scattered areas of the negative electrode plate 142.

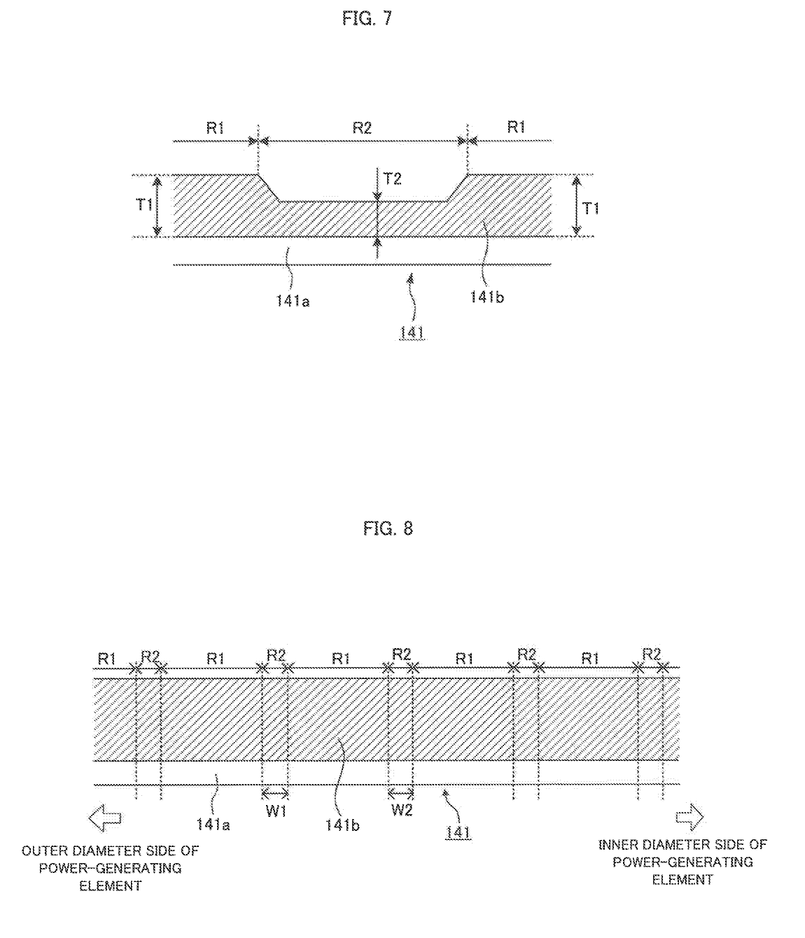

In the present embodiment, to reduce the local precipitation of lithium in the curved portion 14A of the power-generating element 14, the positive electrode active material layer 141b is provided with different structures for the curved region and the flat region of the positive electrode plate 141. FIG. 7 is a section view of the positive electrode plate 141. In FIG. 7, the positive electrode active material layer 141b has a thickness T1 in the flat region R1 and a thickness T2 in the curved region R2.

The flat region R1 shown in FIG. 7 corresponds to the flat portion 14B of the power-generating element 14 in the positive electrode active material layer 141b. The curved region R2 corresponds to the curved portion 14A of the power-generating element 14 in the positive electrode active material layer 141b. The thickness T2 is smaller than the thickness T1. The positive electrode active material layer 141b is composed of the materials (such as the positive electrode active material and the conductive agent) mixed at substantially the same ratio in both the flat region R1 and the curved region R2. In preparing the materials forming the positive electrode active material layer 141b, these materials may not be mixed completely uniformly. Thus, the substantially the same mixture ratio allows nonuniform mixture of the materials forming the positive electrode active material layer 141b to some extent.

In the present embodiment, the thickness T2 of the curved region R2 is set to be smaller than the thickness T1 of the flat region R1 such that the density of the positive electrode active material layer 141b in the curved region R2 can be higher than the density of the positive electrode active material layer 141b in the flat region R1. The density of the negative electrode active material layer 142b is substantially uniform over the entire negative electrode active material layer 142b. The substantially uniform density allows some manufacturing variations in forming the negative electrode active material layer 142b.

In the positive electrode active material layer 141b, the density in the curved region R2 set to be higher than the density in the flat region R1 can suppress the local precipitation of lithium in the curved portion 14A of the power-generating element 14. The flat region R1 of the positive electrode active material layer 141b is flattened by the restraint force F. This easily increases the density of the positive electrode active material layer 141b in the flat region R1 of the positive electrode active material layer 141b.

In contrast, the restraint force F does not effectively acts on the curved region R2 of the positive electrode active material layer 141b, so that the curved region R2 of the positive electrode active material layer 141b is not flattened easily by the restraint force F. Since the density in the curved region R2 is set to be higher than the density in the flat region R1 in the present embodiment, the density in the curved region R2 can be closer to the density in the flat region R1 when the restraint force F is applied to the battery 10. This can reduce variations in current density during charge and discharge between the flat region R1 and the curved region R2 to suppress the local precipitation of lithium in the curved portion 14A of the power-generating element 14.

As shown in FIG. 8, the positive electrode plate 141 may be manufactured by dividing the long positive electrode plate 141 into the flat region R1 and the curved region R2 and providing the different densities of the positive electrode active material layer 141b for the flat region R1 and the curved region R2. The flat region R1 and the curved region R2 are formed alternately in a longitudinal direction of the positive electrode plate 141 (left-to-right direction in FIG. 8).

Since the positive electrode plate 141 is wound in manufacturing the power-generating element 14, the size of the curved region R2 positioned on the inner diameter of the power-generating element 14 is different from the size of the curved region R2 positioned on the outer diameter of the power-generating element 14. Specifically, the size of the curved region R2 positioned on the outer diameter of the power-generating element 14 is larger than the size of the curved region R2 positioned on the inner diameter of the power-generating element 14. Thus, a width W1 of the curved region R2 positioned on the outer diameter of the power-generating element 14 can be larger than a width W2 of the curved region R2 positioned on the inner diameter of the power-generating element 14, for example.

The different widths of the curved region R2 (different lengths in the left-right direction in FIG. 8) can result in the curved regions R2 of the positive electrode plate 141 that match the curved portion 14A of the power-generating element 14. Since the width of the curved region R2 is increased each time the positive electrode plate 141 is turned, the width of the curved region R2 can be increased stepwise from the inner diameter to the outer diameter of the power-generating element 14.

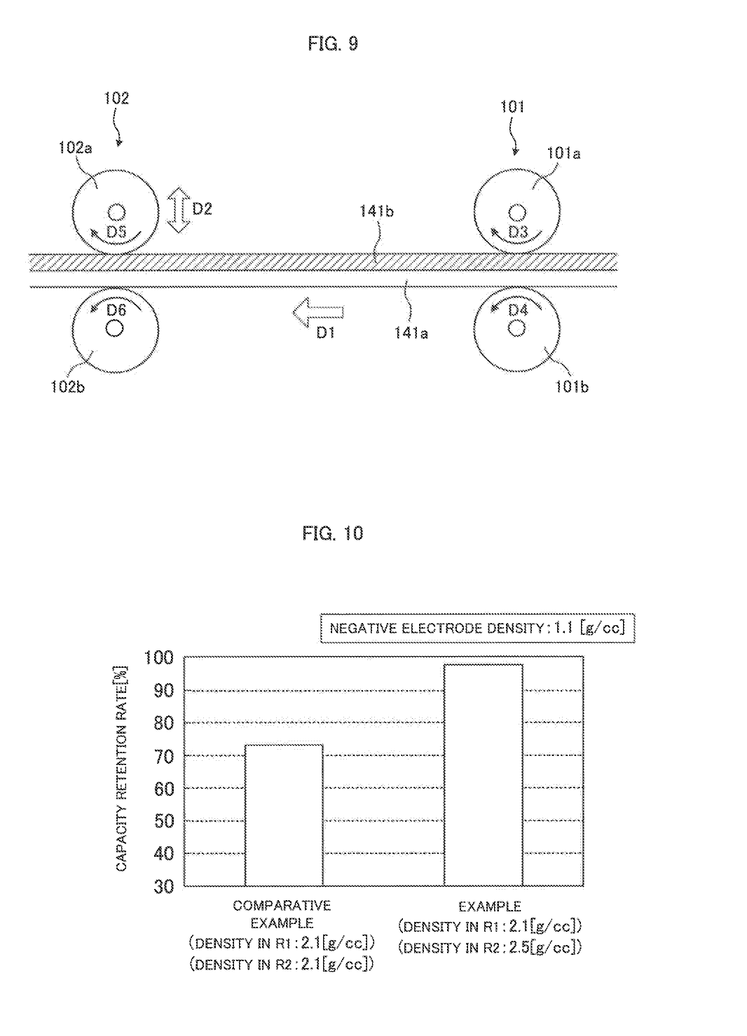

The positive electrode plate 141 can be manufactured by using two press machines. FIG. 9 is a diagram showing part of a process of manufacturing the positive electrode plate 141. The collector plate 141a having the positive electrode active material layer 141b formed thereon passes through a first press machine 101 and a second press machine 102 while moving in a direction indicated by an arrow D1.

Ina step before the step shown in FIG. 9, the positive electrode active material layer 141b is formed on the surface of the collector plate 141a by applying the materials (such as the positive electrode active material and the conductive agent) forming the positive electrode active material layer 141b to the collector plate 141a. The materials forming the positive electrode active material layer 141b can be applied to the surface of the collector plate 141a with an application apparatus such as a gravure coater or a die coater. The materials forming the positive electrode active material layer 141b are applied substantially uniformly to the surface of the collector plate 141a.

The collector plate 141a having the positive electrode active material layer 141b formed thereon passes through the first press machine 101 to adjust the thickness of the positive electrode active material layer 141b. Specifically, the first press machine 101 is used to form the flat region R1 and sets the thickness of the positive electrode active material layer 141b at the thickness T1 of the flat region R1. The first press machine 101 has a pair of rollers 101a and 101b which are rotated in directions indicated by arrows D3 and D4 in FIG. 9, respectively. The interval between the pair of rollers 101a and 101b is fixed.

The second press machine 102 is disposed downstream of the first press machine 101 on a transfer path of the collector plate 141a and has a pair of rollers 102a and 102b. The second press machine 102 is used to form the curved region R2. The pair of rollers 102a and 102b are rotated in directions indicated by arrows D5 and D6 in FIG. 9, respectively. The roller 102a is disposed on the side of the positive electrode active material layer 141b and can also move in directions indicated by an arrow D2. Specifically, the roller 102a moves toward the roller 102b and moves away from the roller 102b.

When the roller 102a is the closest to the roller 102b, the interval between the pair of rollers 102a and 102b is smaller than the interval between the pair of rollers 101a and 101b. The roller 102a closest to the roller 102b depresses the positive electrode active material layer 141b. This reduces the thickness of the positive electrode active material layer 141b to the thickness T2 of the curved region R2 to form the curved region R2 in the positive electrode active material layer 141b. The time period for which the roller 102a is the closest to the roller 102b can be adjusted to control the width of the curved region R2.

After the curved region R2 is formed in the positive electrode active material layer 141b, the roller 102a moves away from the roller 102b. While the roller 102a does not depress the positive electrode active material layer 141a, the collector plate 141a having the positive electrode active material layer 141b formed thereon passes between the pair of rollers 102a and 102b to form the flat region R1.

After the flat region R1 and the curved region R2 are formed in the positive electrode active material layer 141b, the collector plate 141a having the positive electrode active material layer 141b formed thereon undergoes processing such as drying. With these steps, the positive electrode plate 141 is obtained.

The negative electrode plate 142 can be manufactured in the same manner as that for the positive electrode plate 141. First, the negative electrode active material layer 142b is formed on the surface of the collector plate 142a by applying the materials forming the negative electrode active material layer 142b (such as carbon) to the collector plate 142a. Next, the thickness of the negative electrode active material layer 142b is adjusted at a predetermined thickness with a press machine. At this step, only the first press machine 101 described in FIG. 9 may be used. Next, the collector plate 142a having the negative electrode active material layer 142b formed thereon undergoes drying or the like, thereby obtaining the negative electrode plate 142.

Although the portion of the positive electrode active material layer 141b is depressed by the second press machine 102 to provide the different densities for the flat region R1 and the curved region R2 in the present embodiment, the present invention is not limited thereto. It is only required that an electric current should smoothly flow in the curved region R2. When the electric current smoothly flows in the curved region R2, the variations in current density can be reduced between the flat region R1 and the curved region R2. As a result, the local precipitation of lithium can be suppressed in the curved region 14A of the power-generating element 14.

Specifically, the amount of the conductive agent contained in the curved region R2 of the positive electrode active material layer 141b can be set to be larger than the amount of the conductive agent contained in the flat region R1 of the positive electrode active material layer 141b. The amount of the conductive agent contained in the curved region R2 larger than the amount of the conductive agent contained in the flat region R1 allows a smooth flow of electric current in the curved region R2 to reduce the variations in current density. This can suppress the local precipitation of lithium in the curved portion 14A of the power-generating element 14.

The added amount of the conductive agent needs to be varied depending on the flat region R1 and the curved region R2. The varied amounts of the conductive agent cause the density of the positive electrode active material layer 141b in the curved region R2 to be higher than the density of the positive electrode active material layer 141b in the flat region R1. When the thickness T2 of the curved region R2 is equal to or smaller than the thickness T1 of the flat region R1, the density in the curved region R2 is higher than the density in the flat region R1. Even when the thickness T2 of the curved region R2 is larger than the thickness T1 of the flat region R1, the density in the curved region R2 is higher than the density in the flat region R1 depending on the amounts of the conductive agent contained in the curved region R2 and the flat region R1.

Although the thickness T2 of the entire curved region R2 is smaller than the thickness T1 of the flat region R1 in the present embodiment, the present invention is not limited thereto. The thickness of only a portion of the curved region R2 may be smaller than the thickness T1 of the flat region R1. In this case, the local precipitation of lithium can be suppressed in the area where the thickness of the curved region R2 is smaller than the thickness T1 of the flat region R1.

Although the density in all the curved regions R2 corresponding to the curved portion 14A of the power-generating element 14 is higher than the density in the flat region R1 in the present embodiment, the present invention is not limited thereto. Specifically, the density in only some of the plurality of curved regions R2 may be higher than the density in the flat region R1. In this case, the plurality of curved regions R2 include the curved region R2 having the density equal to the density in the flat region R1.

Although the density in the curved region R2 is higher than the density in the flat region R1 in all the batteries 10 constituting the battery stack 1 in the present embodiment, the present invention is not limited thereto. Specifically, the density in the curved region R2 may be higher than the density in the flat region R1 in some of the plurality of batteries 10 constituting the battery stack 1.

FIG. 10 shows experiment results obtained when the positive electrode active material layer 141b had varied densities and when the positive electrode active material layer 141b had a uniform density. In FIG. 10, the vertical axis represents a capacity retention rate. The capacity retention rate refers to a ratio between a capacity C1 of the battery 10 in the initial state and a capacity C2 of the battery 10 deteriorated, and is represented by the following expression (1). Once lithium is precipitated, the number of lithium ions contributing to charge and discharge of the battery 10 is decreased to reduce the capacity retention rate.

Capacity retention rate=C2×100/C1 (1)

In a comparative example shown in FIG. 10, the flat region R1 and the curved region R2 had an equal density, and the density of the entire positive electrode active material layer 141b was set at 2.1 [g/cc]. In an example shown in FIG. 10, the flat region R1 and the curved region R2 had varied densities. Specifically, the density in flat region R1 was set at 2.1 [g/cc] and the density in the curved region R2 was set at 2.5 [g/cc]. In the comparative example and the example, the density of the negative electrode active material layer 142b was uniform and set at 1.1 [g/cc]. The other configurations of the battery 10 were common to the comparative example and the example.

Experimental conditions set when the experimental results shown in FIG. 10 were provided are described in the following.

After the batteries 10 in the comparative example and the example were charged with a constant current at a predetermined rate for 10 seconds, the batteries 10 were left standing for 3 minutes. Next, the batteries 10 were discharged with a constant current at a predetermined rate for 10 seconds and then left standing for 3 minutes. The charge and discharge were defined as one cycle, and 100 cycles were performed. The temperature of the battery 10 was set at 0° C.

After the test of 100 cycles was performed, the processing of adjusting the State of Charge (SOC) of the battery 10 was performed. Specifically, the voltage of the battery 10 was set at 3.73 [V] and discharged with a constant current and a constant voltage at a rate of 1 C for 10 minutes, and then left standing for one minute. Next, the voltage of the battery 10 was set at 3.73 [V] and charged with a constant current and a constant voltage at a rate of 1 C for 10 minutes, and then left standing for one minute. The temperature of the battery 10 was set at 0° C. in the processing of adjusting the SOC of the battery 10.

The test of 100 cycles and the processing of adjusting the SOC of the battery 10 were repeated three times. The temperature of the battery 10 was increased to 25° C., and then the capacity of the battery 10 was measured. The battery 10 was discharged with the constant current after it was fully charged, so that the capacity of the battery 10 can be measured.

Next, the test of 100 cycles and the processing of adjusting the SOC of the battery 10 were again repeated three times. After the temperature of the battery 10 was increased to 25° C., the capacity of the battery 10 was measured. The capacity retention rate shown in FIG. 10 was calculated from the capacity of the battery 10 measured at this point.

As shown in FIG. 10, the capacity retention rate in the example was higher than the capacity retention rate in the comparative example. Thus, it can be seen that the precipitation of lithium can be suppressed in the example than in the comparative example.

In the positive electrode active material layer 141b, a density D_{F} in the flat region R1 and a density D_{C} in the curved region R2 preferably satisfy the relationship represented in the following expression (2):

1.0<D_{C}/D_{F}<1.2 (2)

Since the density D_{C} in the curved region R2 is higher than the density D_{F} in the flat region R1 as described above, the ratio D_{C}/D_{F} is larger than 1.0. The ratio D_{C}/D_{F} is preferably smaller than 1.2. If the ratio D_{C}/D_{F} is equal to or larger than 1.2, the discharge time is shortened or the deterioration proceeds when the battery 10 is discharged at a high rate.

The high rate refers to a rate in which the lithium ions tend to be present in a nonuniform concentration within the positive electrode plate 141 (positive electrode active material layer 141b) or the negative electrode plate 142 (negative electrode active material layer 142b). If the lithium ion concentration is extremely nonuniform, the input/output characteristics of the battery 10 are deteriorated.

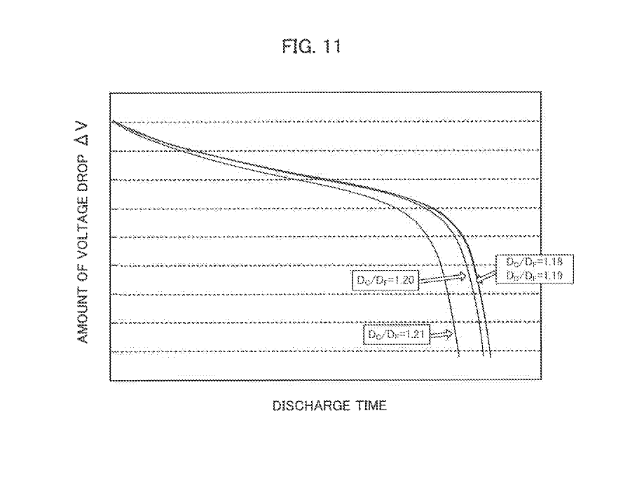

FIG. 11 shows discharge curves when the battery 10 was discharged at a high rate of 20 C. The voltage of the battery 10 before the start of the discharge was set at 3.73 [V]. When the ratio D_{C}/D_{F} was set at 1.18, 1.19, and 1.20, the discharge time did not vary largely. When the ratio D_{C}/D_{F} was set at 1.21, the discharge time was significantly reduced. When the ratio D_{C}/D_{F} was equal to or larger than 1.21, the nonuniformity of the lithium ion concentration was increased to easily deteriorate the battery 10 as compared with the ratio D_{C}/D_{F} smaller than 1.21. For reducing the deterioration of the input/output characteristics of the battery 10, the ratio D_{C}/D_{F} is preferably smaller than 1.2.

1.-10. (canceled)

11. A method of manufacturing a lithium-ion secondary battery comprising the steps of:
forming a positive electrode active material layer on a surface of a positive electrode collector plate to produce a positive electrode plate;
forming a negative electrode active material layer on a surface of a negative electrode collector plate to produce a negative electrode plate; and
stacking the positive electrode plate, the negative electrode plate, and a separator disposed between the positive electrode plate and the negative electrode plate, and winding the stack to form a flat portion disposed along a plane and bearing an external load and a curved portion formed to be curved,
wherein the positive electrode active material layer includes a flat region corresponding to the flat portion and a curved region corresponding to the curved portion, and
in the formation of the positive electrode active material layer on the surface of the positive electrode collector plate, providing a density in at least a portion of the curved region higher than a density in the flat region.

12. The method of manufacturing the lithium-ion secondary battery according to claim 11, wherein a thickness of at least the portion of the curved region is set to be smaller than a thickness of the flat region to provide the density in at least the portion of the curved region higher than the density in the flat region.

13. The method of manufacturing the lithium-ion secondary battery according to claim 12, wherein the thickness of at least the portion of the curved region is set to be smaller than the thickness of the flat region by using a roller movable between a position where the roller presses the positive electrode active material layer and a position where the roller is separate from the positive electrode active material layer.

14. The method of manufacturing the lithium-ion secondary battery according to claim 13, wherein, before the roller presses the positive electrode active material layer, the positive electrode active material layer is formed by applying a plurality of materials forming the positive electrode active material layer at a substantially equal content ratio to the positive electrode collector plate.

15. The method of manufacturing the lithium-ion secondary battery according to claim 11, wherein a density D_{C} in at least the portion of the curved region and a density D_{F} in the flat region satisfy a condition represented by the following expression (III):
1.0<D_{C}/D_{F}<1.2 (III).

16. The method of manufacturing the lithium-ion secondary battery according to claim 12, wherein a density D_{C} in at least the portion of the curved region and a density D_{F} in the flat region satisfy a condition represented by the following expression (III):
1.0<D_{C}/D_{F}<1.2 (III).

17. The method of manufacturing the lithium-ion secondary battery according to claim 13, wherein a density D_{C} in at least the portion of the curved region and a density D_{F} in the flat region satisfy a condition represented by the following expression (III):
1.0<DC/DF<1.2 (III).

18. The method of manufacturing the lithium-ion secondary battery according to claim 14, wherein a density D_{C} in at least the portion of the curved region and a density D_{F} in the flat region satisfy a condition represented by the following expression (III):
1.0<D_{C}/D_{F}<1.2 (III).
